(19) United States
(12) Patent Application Publication
(10) Pub. No.: US 2017/0140345 A1
(43) Pub. Date: May 18, 2017

(54) VOUCHERING SYSTEM AND METHOD FOR ENHANCING AIRPORT-CONCESSION PATRONAGE USING INCENTIVE REWARDS CURRENCY

(71) Applicant: Flo Solutions, New York, NY (US)

(72) Inventors: Albert C. Lee, New York, NY (US); Eric J. Blatstein, New York, NY (US)

(21) Appl. No.: 14/939,506

(22) Filed: Nov. 12, 2015

(51) Int. Cl. G06Q 20/04; G06Q 50/14; G06Q 20/34; G06Q 30/02; G06Q 30/06

(52) U.S. Cl. CPC G06Q 20/0457; G06Q 30/0233; G06Q 20/045; G06Q 30/0631; G06Q 20/34; G06Q 50/14

(57) ABSTRACT

A method for purchasing goods or services with incentive rewards program currency within in an airport terminal or other business environment includes image capture of a voucher into a data processing system, typically configured as a tablet computer. In the illustrative embodiment, the voucher is a boarding pass. The passenger's name or other identifying information is extracted from the image, and the tablet presents, in its display, a menu from which the passenger can select food (or other goods) for purchase from purveyors thereof (e.g., airport concessions or street restaurants or retailers in other business environments) using rewards currency. Once items are selected, the tablet determines, from a balance inquiry and response, whether the passenger has sufficient rewards currency for the purchase. If sufficient, the tablet approves the transaction, transmitting the order and the tablet's location to the appropriate purveyor for order fulfillment.

### FIELD OF THE INVENTION

The present invention relates to incentive rewards systems.

### BACKGROUND OF THE INVENTION

Most U.S. commercial airports are owned and operated by municipal or county authorities. The airports lease gates to airlines in long-term leases, giving the airline exclusive use of those gates. Although most of their revenue comes from the airlines, airport owners do receive income from concessionaires, such as the eateries, book stores, and gift shops that operate within their airline terminals. As profits shrink for the airline industry, and as airport operating costs rise, the revenue from airport concessions becomes increasingly important to airport owners.

Concessionaires are faced with the daily challenge of turning the many somewhat-stressed travelers into paying customers. Although passenger wait times are increasing such that travelers have more time on their hands at airports, they are likely to forego shopping or dining if it's inconvenient or otherwise unpleasant.

Any initiative that enhances a passenger's time in the terminal (e.g., improved efficiency, better quality food, more comfortable surroundings, etc.) is likely to promote the patronage of airport concessions by those passengers. That is good for concessionaires and any party that collects a portion of the concessionaires' profits. And to the extent that a passenger's experience in the terminal is enhanced, at least some of the goodwill generated is likely to accrue to the airline.

### SUMMARY OF THE INVENTION

The illustrative embodiment of the present invention is a data processing system and method that promotes patronage of airport concessions using airline (or other) incentive rewards points/miles, all tied to the presentation of a single voucher, such as an electronic boarding pass.

In accordance with some embodiments of the invention, rewards miles/points (hereinafter collectively referenced as “rewards currency”) that have accrued in a passenger's incentive-rewards-program account are used to pay for goods and services at airport concessions. In the illustrative embodiment, the incentive rewards program is owned by the airline on which the passenger will be traveling, although in other embodiments, incentive rewards currency from other (non-airline) rewards program are used.

In accordance with the illustrative embodiment, a passenger, wishing to purchase goods or services within an airport terminal, activates a data processing system in the form of a tablet computer (e.g., the Apple iPad®, Samsung Galaxy Tab models, etc.) that is configured to function, in addition to any other functionality, as a point-of-sale (“POS”) terminal. In a typical embodiment of the invention, many such POS-configured tablets are distributed throughout the terminal—near the boarding gates, at concessions—anywhere in the terminal. The passenger uses a tablet to photograph or scan, as appropriate, her paper or electronic boarding (“e-boarding”) pass. Hereinafter, the term “boarding pass” is used to refer to either a paper boarding pass or an e-boarding pass. Software on the tablet extracts the passenger's name (and flight information) from the boarding pass. In further embodiments, with a software application (“app”) on the passenger's smart phone and on the tablet, the information from the passenger's boarding pass can be communicated between the smart phone and the tablet via wireless or wired connection.

Having extracted the information from the boarding pass (or loyalty card), the tablet will show, on its display screen, a page that presents goods and services options for the passenger. For example, the page may show a plurality of icons indicating food, beverage, duty-free, and retail as options for the passenger. In the illustrative embodiment, all goods and services options that are presented to the passenger will include airport concessions that accept rewards currency as payment.

After selecting an option, the tablet will display the offerings of one or more concessions in the appropriate category. A description of each such offering appears in the screen with an indication of price given in terms of both money and rewards currency.

The passenger then selects an offering. Depending on system configuration, the tablet either: (1) directly queries the airline's rewards program data processing system for the passenger's rewards currency balance or (2) queries a system server, also part of the data processing system for such embodiments, that queries the airline's rewards program data processing system. In either case, the query utilizes the information (i.e., the passenger's loyalty number or ticket confirmation code) extracted from the passenger's boarding pass.

The tablet (or, in some embodiments, the central server) determines whether the passenger has a sufficient amount of rewards currency to complete the requested transaction. If so, the transaction is approved and completed. The tablet communicates the order to the concession and, if the tablet is not located in the concession, the tablet communicates its location to the concession so that the food, etc., can be delivered to the passenger (assuming they remain at the tablet's location). Thus, by the simple act of presenting the boarding pass (or loyalty card) to the tablet (or simply having one's phone in the vicinity of the tablet if the phone and tablet are appropriately configured), the passenger can order food and have it delivered, etc.

Although some prior-art rewards programs enable members to purchase goods and services, most rewards currency in airline rewards programs are used for travel, regardless of program rules. And, in many cases, the rewards currency in airline rewards programs remains unused in passengers' accounts for long periods of time. Among any other reasons for this is that typically a large number of rewards currency (i.e., miles) must be accrued to fund airline travel. If a passenger travels infrequently, it can take several years to accumulate the requisite amount of rewards currency for “free” travel. The delay to accumulate rewards currency is exacerbated by the fact that people do not always fly the same airlines for their travel; travelers often select a carrier based on price, which can vary based on the destination. In addition to the fact that the passengers do not benefit from such unused rewards currency, the airlines have a liability (free airline travel) in their future.

Facilitating the purchase of goods and services in the airport using airline-carrier rewards currency in accordance with embodiments of the invention provides benefits to airport concessionaires, passengers, airlines, and airport owners alike. Airport concessions benefit from an increase in business. This is due, at least in part, to the benefits the system and method provides to the passenger; namely:
the convenience of the process—by presenting their boarding pass, a passenger can get food, etc., without leaving a seat at the gate and without removing their wallet;
passengers are likely to view their purchases as “free” since they are not paying with money;
embodiments of the invention provide a way for a passenger to use the rewards currency that they might otherwise expect never to use; and
to the extent that a passenger wishes to make a purchase in the terminal but has allocated a certain amount of money for their travel/entertainment, the ability to use rewards currency instead of hard currency or a credit card, makes that purchase more likely.

The airline benefits because of a reduction in a future financial liability, as represented by unused rewards currency, since embodiments of the invention are likely to result in lesser accumulations of reward currency in a member's account. Furthermore, the ability to more readily redeem rewards currency should increase the value of the rewards currency and the program to the passenger, which is expected to accrue as goodwill (and enhanced customer loyalty) for the airline.

Since a percentage of the concessionaire's profits are usually payable to the lessor of the terminal space, the lessor—airport owner or airline—benefits from any increase in concessionaire business.

As previously indicated, the embodiments of the present invention can be used in conjunction with:
business environments other than airport terminals;
vouchers other than a boarding pass; and
incentive rewards issuers other than airlines.
   For example, the business environment can be a restaurant or retail establishment located anywhere (e.g., on the street, in a shopping mall, etc.). The voucher can be a loyalty card, of any rewards program, which enables access to the member's rewards currency. The loyalty card will typically include a magnetic stripe or chip. In such embodiments, the tablet is configured to read the magnetic stripe or chip on the loyalty card. The rewards program issuer/manager can be a credit card company, a restaurant, a retailer, etc. Thus, in some embodiments of the present invention, rewards points in an airline's rewards program, a credit card company's rewards program, etc., can be used to purchase food or beverage from a restaurant located “on the street.” In such embodiments, the purchaser will typically present a loyalty card rather than a boarding pass.

In most embodiments, the establishment accepting the rewards currency is accepting third-party currency. For example, a restaurant (either in an airport terminal or on the street) accepting rewards currency from an airline rewards program is accepting third-party rewards currency. But in some embodiments, it is a first-party relationship; that is, the entity accepting the rewards currency is owned by the rewards program issuer/administrator. An example of this is when, during a flight on airline “U,” a passenger purchases food or beverage with airline U rewards points.

### BRIEF DESCRIPTION OF THE DRAWINGS

FIG. 1 depicts, in a business environment in which it can be used, a data processing system in accordance with the illustrative embodiment of the present invention.

FIG. 2A depicts a first embodiment of the data processing system of FIG. 1, realized as an appropriately configured tablet.

FIG. 2B depicts a second embodiment of the data processing system of FIG. 2, realized as an appropriately configured tablet and a system server.

FIG. 3 depicts the contents of processor-accessible memory of the tablet.

FIG. 4 depicts an embodiment of an exchange rate database for use in conjunction with the illustrative embodiment of the invention.

FIG. 5 depicts tasks performed by the tablet and a rewards program data processing system for the embodiment of the data processing system depicted in FIG. 2A, when implementing a method in accordance with the present invention.

FIG. 6 depicts tasks performed by the tablet, central server, and a rewards program data processing system for the embodiment of the data processing system depicted in FIG. 2B, when implementing a method in accordance with the present invention.

### DETAILED DESCRIPTION

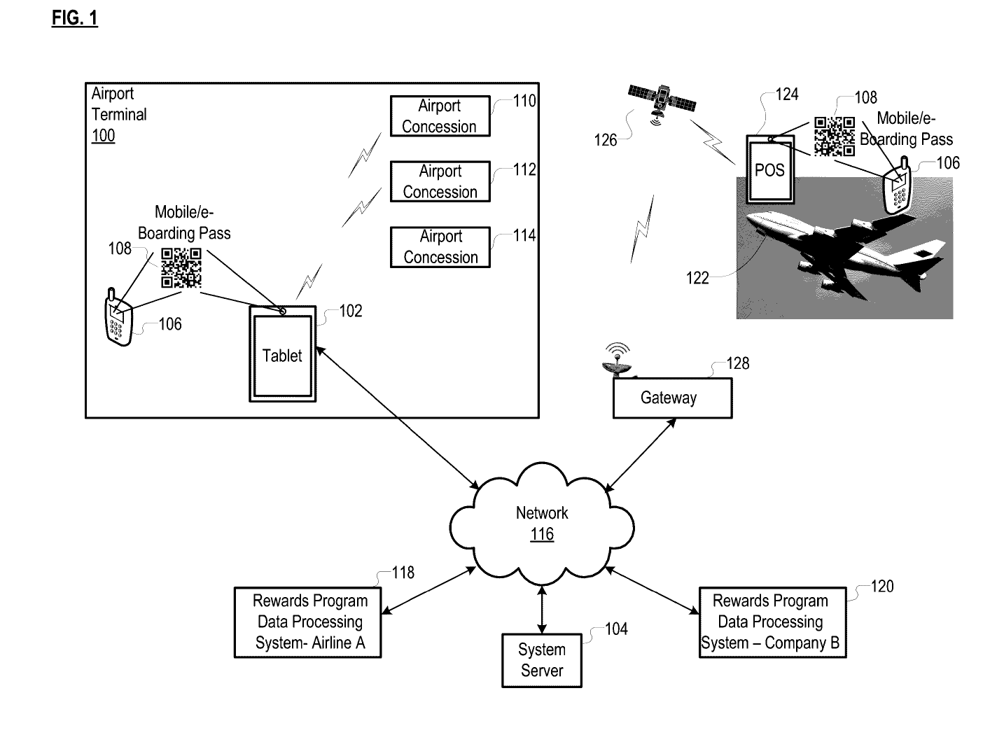

FIG. 1 depicts a data processing system in accordance with an illustrative embodiment and situated in a business environment in which it can be used. More particularly, FIG. 1 depicts airline terminal 100, tablet 102, system server 104, smart phone 106, airport concessions 110, 112, and 114, network 116, rewards program data processing systems 118 and 120, plane 122, point-of-sale terminal (“POS”) 124, satellite 126, and gateway 128, inter-related as shown.

In some embodiments, a data processing system in accordance with the invention is realized a plurality of tablets 102 and/or at least one POSs 124. In some other embodiments, a data processing system in accordance with the invention is realized as a plurality of tablets 102 and/or at least one POS 124 in conjunction with system server 104.

In some embodiments, the owner/operator of the data processing system is a third party that has no ownership interest in any of the airport concessions that are used in conjunction with embodiments of the invention. In such embodiments, the owner/operator of the data processing system benefits by, for example, receiving a portion of the profits from sales attributable to the data processing system and method. In some other embodiments, the operator/owner of the data processing system owns at least one airport concession that accepts rewards currency for goods purchases in the airport terminal in which the invention is being practiced. In such embodiments, the owner/operator of the data processing system benefits by the expected increase in sales due to embodiments of the invention.

In some embodiments, the data processing system is owned/operated by the airline, which enables a level of integration between the various systems (e.g., the data processing system and rewards program data processing system) that is not likely to be possible when the data processing system of the invention is owned/operated by a third party. To the extent that the data processing system and the airline are owned/operated by different parties, agreements must be established therebetween for the embodiments of the invention to be practiced.

It is to be understood that, in the illustrative embodiment, airline terminal 100, smart phone 106, network 116, rewards program data processing systems 118 and 120, plane 122, satellite 126, and gateway 128 are simply elements of the business environment with which embodiments of the invention interact. That being said, some of these elements (e.g., smart phone 106, etc.) may include special software applications to enhance or otherwise facilitate implementation of the embodiments of the invention.

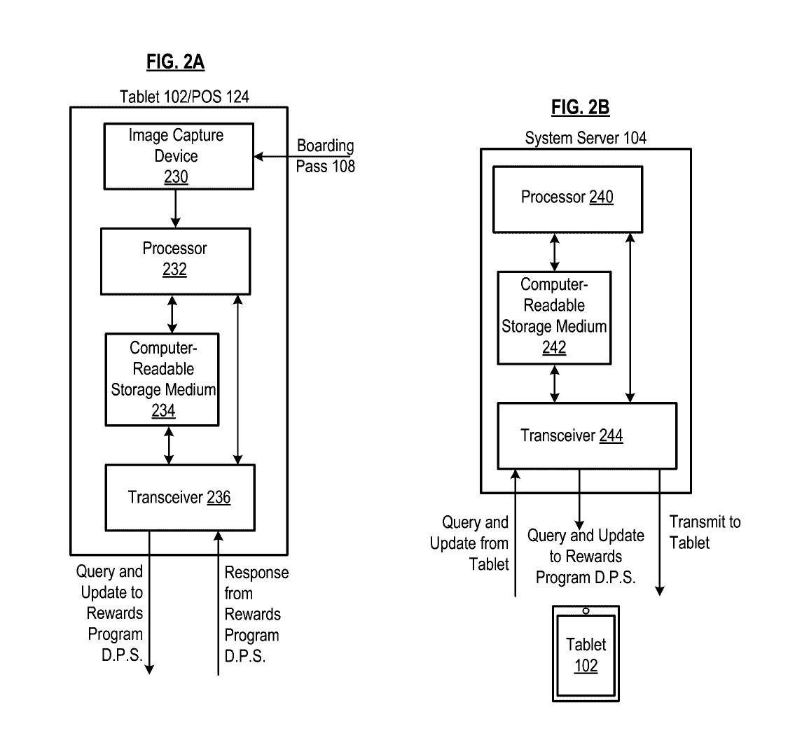

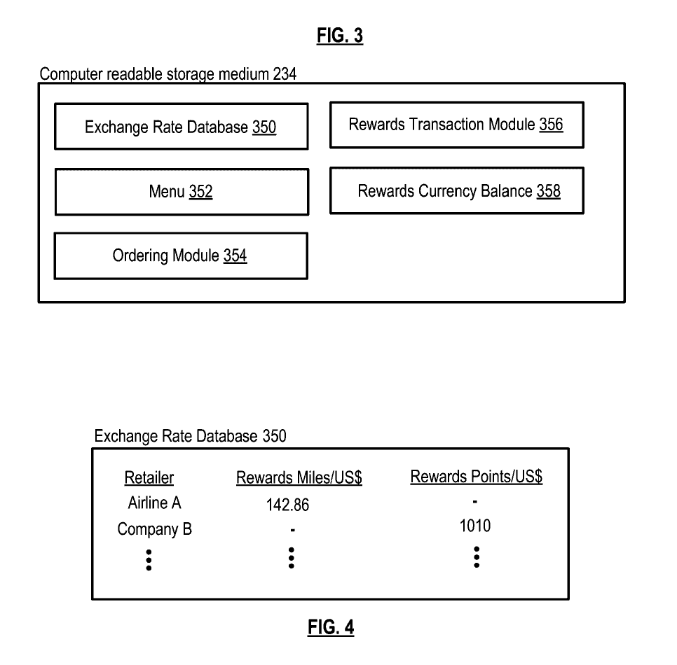

In the illustrative embodiment, tablet 102 and POS 124 are tablet computers, such as the APPLE iPad®, executing specialized software applications stored in the tablet's memory. In some other embodiments, tablet 102 and POS 124 are specialized devices suitable for performing the tasks described in later in this specification. Tablet 102 and POS 124 are described in more detail in conjunction with FIGS. 2A, 3, 4, 5, and 6.

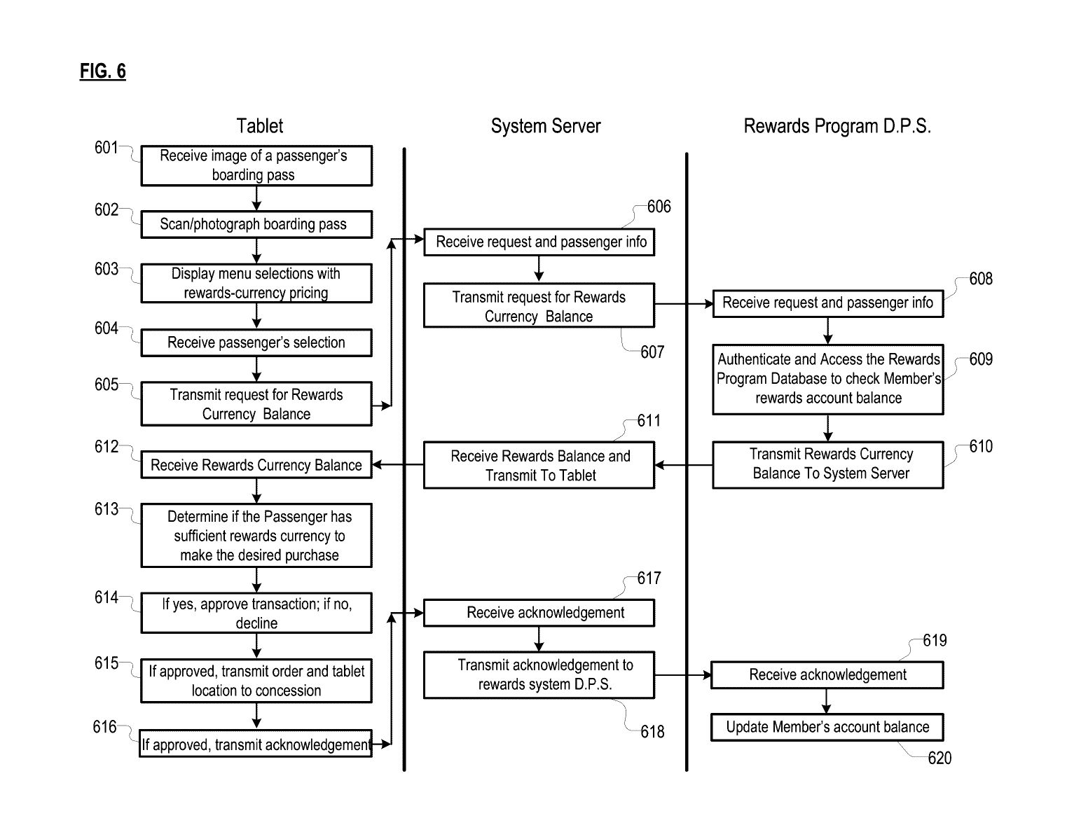

System server 104 is a computer having specialized software applications stored in processor-accessible memory and suitably configured to interface with a wide-area network, such as the Internet. System server 104 is described in further detail in conjunction with FIGS. 2B and 6.

In the illustrative embodiment, the business environment in which embodiments of the invention are practiced include airport terminal 100 and/or passenger plane 122. For the following description, it is assumed that a passenger in terminal 100 has e-boarding pass 108 on smart phone 106. As previously indicated, embodiments of the invention can be used with a paper boarding pass, as well. It is further assumed that the passenger has a rewards currency account, and a balance of rewards currency therein, in a rewards program of “Airline A,” with which the passenger is going to fly that day.

In accordance with the illustrative embodiment of the invention, tablets 102 have been distributed throughout terminal 100 for use by passengers as they wait for their flights. Tablets 102 are configured to execute specialized software that enable them to provide the functionality described herein.

The passenger, sitting at the departure gate for their flight, accesses one of the many tablets 102 situated at tables and seats in the gate area (and elsewhere). The passenger can use the tablet to access the Internet, play games, or do anything that a user of a tablet computer can normally do. If, however, the passenger uses tablet 102 to photograph (or scan if appropriately configured) their e-boarding pass, then further functionality of tablet 102 becomes available to the passenger.

In particular, in some embodiments, the passenger is presented, in the display screen of tablet 102, with options that enable the purchase of various good or services using rewards currency of Airline A. In the illustrative embodiment, the goods or services are offered from concessions operating in terminal 100. For example, airport concession 110 is a restaurant that accepts Airline A rewards currency, airport concession 112 is a gift shop that accepts Airline A rewards currency, and airport concession 114 is a restaurant that does not accept Airline A rewards currency. The display therefore presents icons that indicate the passenger can purchase food (from concession 110) or gifts (from concession 112).

If the passenger indicates she wishes to purchase food, a menu of offerings available from concession 110 is presented in the display of tablet 102. In some embodiments, for each menu item, a price in dollars (or other appropriate hard currency) and a price in rewards currency is displayed. The passenger can then make a selection, indicating (by selecting the appropriate currency option) whether they wish to pay with hard currency or rewards currency.

Assuming the passenger indicates that they wish to pay with rewards currency, tablet 102 must determine (or otherwise be advised) whether the passenger has sufficient rewards currency in their rewards accounts. In some embodiments, tablet 102 queries Airline A rewards data processing system 118, via a wide-area network (“WAN”) 116, such as the Internet, for the passenger's rewards account balance. System 118 responds with the passenger's account balance. In some other embodiments, tablet 102 directs the query for the rewards account balance, via WAN 116, to system server 104. The system server then sends a request for the rewards account balance, over WAN 116, to Airline A rewards data processing system 118. The account balance is returned to system server 104 and from there to tablet 102.

In some embodiments, having received the passenger's rewards-currency balance, tablet 102 calculates whether the passenger has sufficient rewards currency to satisfy the balance owing. If the passenger has sufficient rewards currency, the transaction is executed; if not, the request to pay with rewards currency is denied. In some embodiments, if the request is denied, the passenger is queried as to whether they wish to pay with a credit card.

In some other embodiments, Airline A will partner with one or more other rewards program issuers, such as that of “Company B.” In such embodiments, at least some of the airline concessions that accept Airline A rewards currency will accept Company B rewards currency. Thus, if a passenger has insufficient Airline A rewards currency to complete a desired purchase, they can fund the balance with Company B rewards currency. In such embodiments, tablet 102 will communicate with Company B rewards program data processing system 120 for rewards currency balance information.

If the transaction is executed, tablet 102 transmits a message to the appropriate concession (concession 110 in the example). Assuming that the passenger is not seated in concession 110, tablet 102 transmits its own location to concession 110. Concession 110 will thus fill the order and deliver it to the location of tablet 102.

If the transaction is approved, tablet 102 transmits a confirmation to Airline A rewards program data processing system 118, either directly or via system server 104, depending on the system configuration. System 118 updates the passenger's rewards currency balance.

Those skilled in the art will recognize that many of the aforementioned tasks can be performed in an order different than discussed above.

Once on Airline A's airplane 122, the passenger can continue to utilize embodiments of the invention. In some embodiments, the passenger can order food or beverage on airplane 122 using their e-boarding pass, paying with rewards currency. In particular, the passenger presents phone 106, with e-boarding pass 108 (or a paper boarding pass) displayed, to a flight attendant who is in possession of POS 124. The POS photographs or scans boarding pass 108. As previously indicated, a paper boarding pass can be used rather than an e-boarding pass. A screen with purchase options, payable with rewards currency, is presented in the display of POS 124. The passenger indicates their selection to the flight attendant who enters the selection into POS 124. In some embodiments, POS 124 obtains the passenger's rewards currency balance via satellite communications, as effected via satellite 126 and gateway 128.

In some embodiments, a passenger's food/beverage ordering history, either immediately prior to the flight in terminal 100, or during prior flights on Airline A, is used to make food/beverage recommendations for the passenger. For example, in some embodiments, the passenger downloads an APP on their smart phone that tracks their purchase history using rewards currency via the present system. Once on the plane, when POS 124 obtains a photo or scan of the passenger's e-boarding pass 108, it queries the smart phone for the ordering history. In some embodiments, based on the order history, POS 124 will make a recommendation for the passenger. For example, if the passenger has regularly ordered a bloody Mary on past flights, POS 124 will suggest a bloody Mary for the passenger. The recommendation is relayed by the flight attendant to the passenger. In some other embodiments, recommendations can be transmitted from POS 124 to an on-board system that displays information on the seat-back displays. Since e-boarding pass 108 includes the passenger's seat number, the recommendations for any given passenger can be made to appear in the seat-back display directly in front of the passenger.

Although an airport terminal is a preferred business environment for using embodiments of the invention, it is to be understood that embodiments of the invention can be used in other business environments. For example, the data processing system can be used and the method performed in the context of restaurants or retailers that are outside of and unrelated to an airport. In such embodiments, the data processing system, in the form of a tablet, can be situated at each table in a restaurant, or a plurality of such tablets can be disposed on bar at a drinking establishment. Or, in the case of a retailer, the tablets can be located throughout the store at various locations (e.g., a few in every aisle).

FIG. 2A depicts a simplified block diagram of a data processing system, embodied as tablet 102 and/or POS 124, in accordance with an illustrative embodiment of the present invention. Tablet 102 includes image capture device 230, processor 232, computer-readable storage medium 234, and transceiver 236.

A conventional tablet computer, such as an Apple iPad®, includes the hardware referenced above. Briefly, image capture device 230 comprises a camera and/or scanner capable of capturing an image, such as a boarding pass, which is in the form of a 2d bar code (i.e., QR code). Processor 232 is a general-purpose processor that is capable of, among other tasks, executing an operating system, executing specialized application software used in conjunction with the embodiments of the invention, and populating, updating, using, and managing data in computer-readable storage medium 234. In some alternative embodiments of the present invention, processor 232 is a special-purpose processor. It will be clear to those skilled in the art how to make and use processor 232.

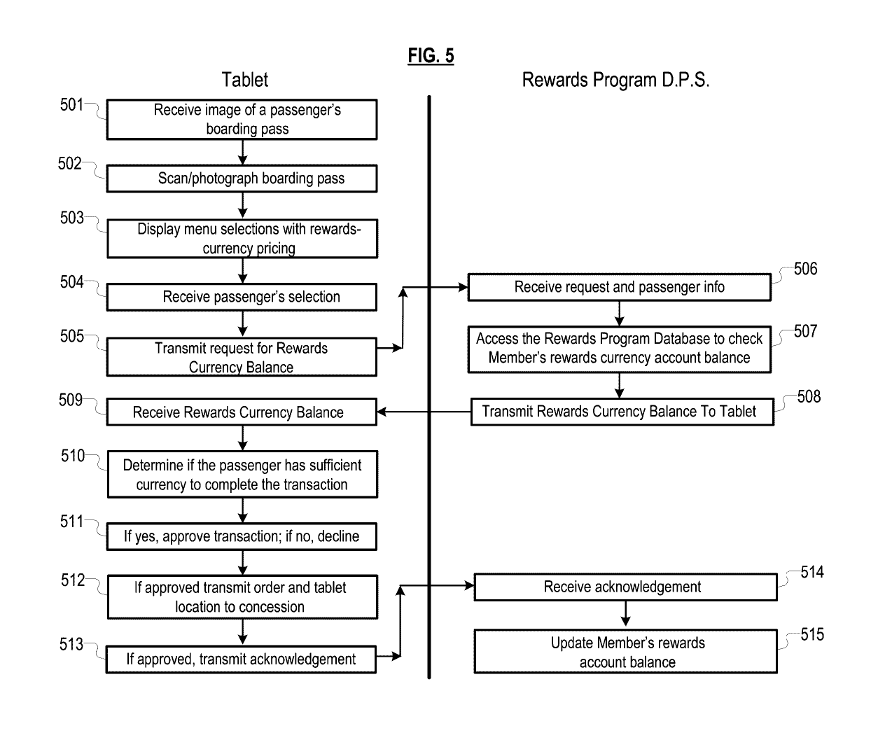

Computer-readable storage medium 234 is a non-volatile, non-transitory memory technology (e.g., RAM, ROM, EPROM, EEPROM, hard drive(s), flash drive(s) or other solid state memory technology, CD-ROM, DVD, etc.) that stores, among any other software and data, specialized application software, such as discussed in FIGS. 3 and 4, which, when executed, enable processor 232 to perform the features and tasks of the various embodiments of the invention. It will be clear to those skilled in the art how to make and use processor-accessible storage 234.

The term “non-transitory” is to be understood to remove only propagating transitory signals per se from claim scope and does not relinquish rights to all standard computer-readable media that are not only propagating transitory signals per se.

Transceiver(s) 236 enables tablet 102 to communicate with other devices and systems, via one or more communications protocols (e.g., Blue-tooth, WiFi, cellular, etc.). Tablet 102 is suitably configured to communicate with airport terminal concessions, so as to transmit a food, beverage, or gift order and to transmit its location so that the order can be delivered to the passenger. It is also suitably configured to communicate with remote servers (e.g., Rewards Program data processing system 118, system server 104, etc.) accessible via a WAN such as the Internet. It will be clear to those skilled in the art, after reading this specification, how to make and use transceiver 236.

FIG. 2B depicts a simplified block diagram of a data processing system, embodied as tablet 102 and/or POS 124 and system server 104, in accordance with another illustrative embodiment of the present invention. Tablet 102/POS 124 is described in FIG. 2A; system server 104 includes processor 240, processor-accessible storage 242, and transceiver 244. Processor 240, processor-accessible storage 242, and transceiver 244 are adequately described as above for processor 232, processor-accessible storage 234, and transceiver 236.

FIG. 3 depicts some of the contents of processor-accessible memory 234 in tablet 102/POS 124. In particular, memory 234 contains exchange-rate database 350, menu(s) 352, ordering module 354, rewards transaction module 356, and rewards currency balance database 358. It is to be understood that these software modules are “logical” entities in the sense that some or all of the functionality provided by any one or more of such modules can be performed by any other module or all the functionality can be combined into a single module or any number of modules as appropriate. The same is true of the databases.

Exchange rate database 350 is depicted in further detail in FIG. 4. This database provides, for each rewards issuer, an exchange rate; that is, the value of that issuer's rewards currency referenced to a hard currency, such as the U.S. dollar. For example, in FIG. 4, Airline A values their rewards currency at 142.86 rewards miles per US dollar. So, if a concession offered an item for US$7.00, it would “cost” a passenger 1000 rewards miles. And for executing the transaction in rewards currency, the rewards program issuer would compensate the concession based on the stated exchange rate. Typically, the rewards program issuer sets the value for their rewards currency.

Returning to the description of FIG. 3, in some embodiments, processor-accessible memory 234 includes menu(s) 352 for any concessions that accept rewards currency for purchases. In some other embodiments, tablet 102/POS 124 downloads a menu in real time from the appropriate airport concession.

The passenger's tentative order is obtained via ordering module 354. The ordering module accepts an order as provisional or tentative subject to a determination that the passenger has sufficient rewards currency in their rewards account to make the purchase. If it is determined that the passenger has sufficient rewards currency, ordering module 354 accepts the order and causes the order and the location of tablet 102 to be transmitted to the appropriate concession for fulfillment and delivery.

In the illustrative embodiment, rewards transaction module 354 provides the following functionality:
generates the equivalent price in rewards currency for each menu item based on exchange rate database 350;
transmits a request for the passengers rewards currency balance;
determines whether the passenger has sufficient rewards currency in their account to make the purchase; and
transmits an update to the rewards program server (either directly or via system server 104) advising of the completed transaction so that the appropriate amount of rewards currency is deducted from the passenger's account.

To determine the sufficiency of the passenger's rewards currency balance, the rewards transaction module 354 compares the amount of rewards currency that is required to complete the transaction with the passenger's rewards currency balance. If the balance equals or exceeds the purchase price, the balance is sufficient. The passenger's rewards currency balance is obtained from the appropriate rewards program data processing system (e.g., see, FIG. 1, system 118, etc.), either directly or via system server 104, and temporarily stored in rewards currency balance database 358.

FIG. 5 depicts the tasks performed by a data processing system in accordance with the invention and a rewards program data processing system in an embodiment wherein the data processing system is embodied as tablet 102, sans system server 104. It is to be understood that the order of the tasks depicted in FIG. 5 is presented by way of illustration, not limitation. As appropriate, a number of the tasks can be performed in a different order than presented.

In accordance with task 501, tablet 102 receives an image of a passenger's boarding pass. Per task 502, tablet 102 photographs or scans the image with appropriate 2d-bar code reader software. In task 503, the tablet displays menu selections with rewards-currency and hard-currency pricing. It is to be understood that this task may involve several sub-tasks, such as first presenting goods options to the passenger (e.g., food, drink, gifts, etc.) and then, after the passenger selects the particular goods, a menu is presented.

In task 504, tablet 102 receives the passenger's selection and, in task 505, the tablet transmits, to the reward program data processing system, a request for the passenger's rewards-currency balance.

The rewards program data processing system receives the request and passenger information in task 506, authenticates the passenger as a member of the rewards program and accesses the rewards program database to check the member's rewards currency balance in task 507, and transmits the balance to tablet 102 in task 508.

Tablet 102 receives the passenger's rewards currency balance, per task 509. The tablet compares, in task 510, the passenger's rewards balance to the amount of rewards currency required to purchase the selected goods. If the balance is sufficient, the transaction is allowed; if not, it is declined, per task 511.

If the transaction is allowed, the passenger's order, along with the tablet's location, is transmitted in task 512 to the appropriate concession. In accordance with task 513, if the transaction is approved, tablet 102 transmits an acknowledgement to the rewards program data processing system.

The rewards program data processing system receives the acknowledgement per task 514 and updates the member's account balance in task 515.

FIG. 6 depicts the tasks performed by a data processing system in accordance with the invention and a rewards program data processing system in an embodiment wherein the data processing system is embodied as tablet 102 and system server 104. It is to be understood that the order of the tasks depicted in FIG. 6 is presented by way of illustration, not limitation. As appropriate, a number of the tasks can be performed in a different order than presented.

In accordance with task 601, tablet 102 receives an image of a passenger's boarding pass. Per task 602, tablet 102 photographs or scans the image with appropriate 2d-bar code reader software. In task 603, the tablet displays menu selections with rewards-currency and hard currency pricing. It is to be understood that this task may involve several sub-tasks, such as first presenting goods options to the passenger (e.g., food, drink, gifts, etc.) and then, after the passenger selects the particular goods, a menu is presented.

In task 604, tablet 102 receives the passenger's selection and, in task 605, the tablet transmits, to system server 104, a request for the passenger's rewards-currency balance.

The system server receives the request and passenger information in task 606. In task 607, system server transmits a request for the passenger's rewards-currency balance, along with passenger information, to the rewards program data processing system.

Per task 608, the rewards program data processing system receives the balance inquiry and passenger information. In task 609, rewards program server authenticates the passenger as a member of the rewards program and accesses the rewards program database to check the member's rewards currency balance. In task 610, the rewards program data processing system transmits the rewards currency balance to system server 104.

In task 611, system server 611 receives the passenger's rewards currency balance and transmits it to tablet 102.

Tablet 102 receives the passenger's rewards currency balance in task 612 and determines, in task 613, whether the passenger has sufficient rewards currency to fund the requested purchase. Per task 614, if the passenger has a sufficient balance in their rewards account, the transaction is approved; if not, the transaction is declined.

If the transaction is approved, tablet 102 transmits the order and the tablet's location to the appropriate airport concession, in accordance with task 615. Furthermore, if the transaction is approved, tablet 102 transmits an acknowledgement to system server 104 in task 617. The system server transmits the acknowledgement to the rewards program data processing system in task 618. Per task 619, the rewards program data processing system receives the acknowledgment and, in accordance with task 620, the server updates the member's rewards program account balance.

It is to be understood that the disclosure describes a few embodiments and that many variations of the invention can easily be devised by those skilled in the art after reading this disclosure and that the scope of the present invention is to be determined by the following claims.

What is claimed is:

1. A method for conducting a rewards-currency-based transaction for goods or services, comprising:
receiving, at a first data processing system, information encoded in a voucher, wherein the information includes at least one of: an identifier of a passenger and an identifier of a rewards account of the passenger in an incentive rewards program;
receiving, at the first data processing system, a request from the passenger to purchase first goods or services using rewards currency from the rewards account, wherein the first goods or services are sourced from a purveyor thereof that accepts rewards currency for the purchase of goods or services; and
one of approving or declining the purchase, at the first data processing system, wherein:
a) the purchase is approved when the passenger has sufficient rewards currency to pay for the first good or services; and
b) the purchase is declined when the passenger has insufficient rewards currency to pay for the first goods or services.

2. The method of claim 1 wherein the first data processing system comprises a tablet computer.

3. The method of claim 2 wherein the tablet computer includes a camera, and wherein the method further comprises using the camera to obtain an image of the voucher, wherein the information encoded in the voucher is obtained from the image.

4. The method of claim 3 wherein the voucher appears in a display on a smart phone belonging to the passenger, and wherein using the camera to obtain the image further comprises taking a picture of the voucher appearing in the display.

5. The method of claim 1 further comprising receiving a first value representative of an amount of rewards currency available to the passenger to purchase goods or services.

6. The method of claim 5 wherein receiving the first value further comprises:
transmitting, from the first data processing system to a data processing system of the incentive rewards program, a query as to the amount of rewards currency available to the passenger; and
receiving, at the first data processing system from the incentive rewards program data processing system, the amount of rewards currency available to the passenger.

7. The method of claim 5 wherein approving the purchase further comprises:
determining a second value that represents an amount of rewards currency required to purchase the first goods or services;
comparing the first value to second value; and
approving the purchase when the first value equals or exceeds the second value.

8. The method of claim 7 wherein determining a second value further comprises:
accessing, at the first data processing system, an exchange rate between hard currency and rewards currency; and
expressing the purchase price of the first goods or services in rewards currency by applying the exchange rate to a purchase price set by the purveyor, in hard currency, of the first goods or services.

9. The method of claim 5 wherein declining the purchase further comprises:
determining a second value that represents an amount of rewards currency required to purchase the first goods or services;
comparing the first value to second value; and
declining the purchase when the first value is less than the second value.

10. The method of claim 9 and further wherein, when the purchase is declined, receiving, at the first data processing system, a credit card number of the passenger.

11. The method of claim 1 wherein when the purchase is approved, the method further comprising transmitting from the first data processing system to the purveyor of the first goods or services, an order for the first goods or services.

12. The method of claim 1 wherein when the purchase is approved, the method further comprises transmitting, from the first data processing system to the purveyor of the first goods or services, a location of the first data processing system.

13. The method of claim 1 wherein when the purchase is approved, the method further comprises transmitting, to a data processing system of the incentive rewards program, acknowledgment of the purchase and an amount of rewards currency used for the purchase.

14. The method of claim 1 wherein receiving the information encoded in the voucher further comprises wirelessly transmitting, from a smart phone of the passenger to the first data processing system, the information encoded in the voucher.

15. The method of claim 1 and further comprising receiving, at the first data processing system, a history of purchases of goods or services made by the passenger using rewards currency.

16. The method of claim 15 and further comprising displaying, at the first data processing system, a recommendation for the passenger of goods or services to purchase based on the history.

17. The method of claim 16 and further comprising, displaying the recommendation on a seat-back display on an airplane.

18. The method of claim 2 and further wherein the tablet computer is located proximate to passenger seating in a waiting area in the airport terminal and the purveyor of the goods and services is located in the airport terminal.

20. The method of claim 1 and further wherein the incentive rewards program is administered by an airline.

21. The method of claim 1 wherein there is a third-party relationship between an administrator of the incentive rewards program and the purveyor of the goods and services.

22. The method of claim 1 wherein there is a first-party relationship between an administrator of the incentive rewards program and the purveyor of the goods and services.

23. The method of claim 1 wherein the voucher is an electronic boarding pass.

24. The method of claim 1 wherein the voucher is a paper boarding pass.

25. The method of claim 1 wherein the voucher is a loyalty card comprising one of a magnetic stripe or an electronic chip.

26. An article of manufacture including non-transitory, tangible computer readable storage medium having instructions stored thereon that, in response to execution by a processor of a first data processing system, cause the first data processing system to perform operations comprising:
receiving, at the first data processing system, information encoded in a voucher, wherein the information includes at least one of: an identifier of a passenger and an identifier of a rewards account of the passenger in an incentive rewards program;
receiving, at the first data processing system, a request from the passenger to purchase first goods or services using rewards currency from the rewards account, wherein the first goods or services are sourced from a purveyor thereof that accepts rewards currency for the purchase of goods or services; and
one of approving or declining the purchase, at the first data processing system, wherein:
a) the purchase is approved when the passenger has sufficient rewards currency to pay for the first good or services; and
b) the purchase is declined when the passenger has insufficient rewards currency to pay for the first goods or services.
